(19) United States
(12) Patent Application Publication
(10) Pub. No.: US 2025/0263137 A1
(43) Pub. Date: Aug. 21, 2025

(54) ACTIVE AIR FLAP DEVICE FOR VEHICLE

(71) Applicants: Hyundai Motor Company, Seoul (KR); Kia Corporation, Seoul (KR); Hanon Systems, Daejeon (KR)

(72) Inventors: Woo Jae KWON, Suwon-si (KR); Ok Ryul MIN, Daejeon (KR); Sung Wook PARK, Daejeon (KR)

(21) Appl. No.: 18/887,616

(22) Filed: Sep. 17, 2024

(30) Foreign Application Priority Data
Feb. 15, 2024 (KR) 10-2024-0021503

(51) Int. Cl. B62D 35/00

(52) U.S. Cl. CPC B62D 35/005

(57) ABSTRACT

An active air flap device for a vehicle is configured to prevent aerodynamic loss caused by the active air flap being twisted. The active air flap device for a vehicle has a structure in which a clutch link is connected between a drive shaft connected to an actuator and a drive link configured to rotate a flap to allow the drive shaft and the clutch link to rotate together to transmit a rotational driving force for opening and closing the flap to the drive link, allowing the clutch link to rotate up to a set angle and the drive shaft to further rotate by an arbitrary angle from the set angle to thereby compensate for a rotation loss in which another end portion of the flap rotates less than one end portion of the flap.

### CROSS-REFERENCE TO RELATED APPLICATION

This application claims, under 35 U.S.C. § 119(a), the benefit of and priority to Korean Patent Application No. 10-2024-0021503, filed on Feb. 15, 2024, the entire contents of which are incorporated herein by reference.

### TECHNICAL FIELD

The present disclosure relates to an active air flap device for a vehicle. More particularly, it relates to an active air flap device for a vehicle capable of preventing aerodynamic loss due to twisting of the active air flap.

### BACKGROUND

An active air flap may be mounted at a predetermined position on a front surface portion of a vehicle and controlled to be closed to block air flowing into a radiator grille or a bumper grille when the temperature of cooling water is equal to or less than a predetermined temperature while travelling, reducing driving resistance caused by air flow to thereby improve vehicle fuel efficiency.

For example, when the temperature of cooling water for an engine exceeds a predetermined temperature in an internal combustion engine vehicle or, when the temperature of cooling water for cooling a motor or a battery exceeds a predetermined temperature in an electric vehicle, the active air flap may be controlled to be open to allow outside air, such as a travelling wind, to be introduced into a radiator and the like through which cooling water flows, thereby cooling the cooling water flowing through the radiator.

In some cases, when the temperature of cooling water for the engine is equal to or less than a predetermined temperature in the internal combustion engine vehicle or, when the temperature of cooling water for cooling the motor or the battery is equal to or less than a predetermined temperature in the electric vehicle, the active air flap may be controlled to be closed to block outside air, such as a travelling wind, from flowing into a radiator and the like through a radiator grille or a bumper grille, reducing driving resistance caused by air flow to thereby improve fuel efficiency or battery efficiency of the vehicle.

In some cases, as the number of electronic components mounted in an electric vehicle increases and thus the performance of a heat exchanger, such as a radiator, needs to be improved, the length of the air passage in the active air flap and the length of the flap are increasing in order to increase the amount of air flowing in through the opening of the radiator grille or bumper grille at the front of the vehicle.

An active air flap in related art includes a housing having formed therein an air passage, a flap disposed to be openable and closable in the air passage, a drive shaft configured to transmit a rotational driving force to the flap, and an actuator configured to rotate the drive shaft.

The flap may be rotated to be open or closed through a process of rotating the drive shaft by driving of the actuator and a process of transmitting a rotational force from the drive shaft to the flap.

In some cases, although the rotational driving force of the actuator is properly transmitted to one end portion of the drive shaft connected to the output portion of the actuator, the rotational driving force is not properly transmitted to another end portion of the drive shaft that is away from the output portion of the actuator, twisting the flap when the rotational driving force is transmitted from the drive shaft to the flap to cause aerodynamic loss.

For instance, although one end portion of the flap that receives the rotational driving force from the one end portion of the drive shaft may be rotated in a closing direction by a desired extent, the rotational driving force transmitted from the actuator gradually decreases toward the other end portion of the drive shaft, and at the same time, the rotational driving force transmitted from the drive shaft gradually decreases toward another end portion of the flap, causing twisting of the flap in which the other end portion of the flap is rotated approximately 5° to 15° less compared to the one end portion of the flap.

As such, when the other end portion of the flap is rotated less compared to the one end portion of the flap to twist the flap, a gap is generated between an air passage in a housing and the other end portion of the flap when the flap is closed. This may cause aerodynamic loss, such as, outside air being passed through the gap, thereby limiting the active air flap from performing its original function, which is to block outside air to reduce driving resistance.

### SUMMARY

The present disclosure has been made in an effort to solve the above-described problems associated with the prior art, and an object of the present disclosure is to provide an active air flap device for a vehicle having a structure in which a clutch link is connected between a drive shaft connected to an actuator and a drive link configured to rotate a flap to allow the drive shaft and the clutch link to rotate together to transmit a rotational driving force for opening and closing the flap to the drive link, allowing the clutch link to rotate up to a set angle and the drive shaft to further rotate by an arbitrary angle from the set angle to thereby compensate for a rotation loss in which another end portion of the flap rotates less than one end portion of the flap.

In one aspect, the present disclosure provides an active air flap device for a vehicle, the device including a housing having formed therein an air passage, a flap disposed to be openable and closable in the air passage, an actuator mounted to one side portion of the housing, a drive shaft connected to the actuator, a clutch link, by being coupled to one end portion of the drive shaft, configured to rotate together with the drive shaft up to a set angle to transmit a rotational driving force to one end portion of the flap, and then to allow the drive shaft to rotate further by an arbitrary angle from the set angle, and a transmission link, by being coupled to another end portion of the drive shaft, configured to rotate by an angle same as the arbitrary angle to transmit the rotational driving force to another end portion of the flap when the drive shaft rotates further by the arbitrary angle.

In some implementations, the active air flap device may further include a first drive link configured to rotate the flap in an opening or closing direction by being hinged between the clutch link and one side portion of the flap, and a second drive link configured to rotate the flap in the opening or closing direction by being hinged between the transmission link and another side portion of the flap.

In some implementations, an external gear meshing with an internal gear for output of the actuator may be provided at one end of the drive shaft.

In some implementations, the clutch link may include a lower fastening tube, having a structure in which a first cut surface and a second cut surface facing each other are spaced apart from each other, being inserted into a through hole formed in one side wall of the housing, and into which the one end portion of the drive shaft is inserted to be fastened, an upper fastening rod coupled to the first drive link by extending from the lower fastening tube, and a stopper protruding from an external side end portion of the lower fastening tube.

In some implementations, the clutch link may further include an elastic pressing end being pressed to a surface of the drive shaft, at each of the first cut surface and the second cut surface of the lower fastening tube.

In some implementations, the one end portion of the drive shaft may have formed thereon a rotation compensating end, protruding therefrom and being disposed between the first cut surface and the second cut surface of the clutch link.

In some implementations, the outer circumferential portion of the through hole in the housing may have formed thereon a first rotation limiting end and a second rotation limiting end, configured to limit a rotation angle of the clutch link rotating together with the drive shaft to a set angle by being brought into contact with the stopper.

In some implementations, the external surface of the upper end portion of the upper fastening rod of the clutch link may have formed thereon a first hinge fin, and the lower end portion of the first drive link may have formed therein a first hinge hole into which the first hinge fin is inserted.

In some implementations, a first impact support rib configured to support the lower end portion of the first drive link may protrude from a position below the first hinge fin on the external surface of the upper fastening rod.

In some implementations, one side surface of the flap may have mounted thereto a fixed link including a second hinge fin, and an upper end portion of the first drive link may have formed therein a second hinge hole into which the second hinge fin is inserted.

In some implementations, a second impact support rib configured to support the upper end portion of the first drive link by being inserted into a support groove formed in an inner surface of the upper end portion of the first drive link may protrude from a position below the second hinge fin on the fixed link.

In some implementations, when the drive shaft and the clutch link rotate together, the stopper of the clutch link may be brought into contact with the first rotation limiting end or with the second rotation limiting end to allow the clutch link to rotate up to a set angle of 90°.

In some implementations, when the drive shaft and the clutch link rotate together up to the set angle and then the drive shaft rotates further by an arbitrary angle from the set angle, the drive shaft may rotate further by the arbitrary angle of 10° from the set angle due to the rotation compensating end being brought into contact with the first cut surface or with the second cut surface of the clutch link.

In some implementations, the one side portion of the housing may have mounted thereto a protection cover configured to protect the one end portion of the drive shaft, the clutch link, and the first drive link.

Other aspects and example implementations of the present disclosure are discussed infra.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure.

FIG. 1 is a perspective view showing an example of an active air flap in related art.

FIG. 2 is a perspective view showing another example of an active air flap in related art.

FIG. 3A and FIG. 3B are exploded perspective views illustrating an example of an active air flap device for a vehicle according to the present disclosure.

FIG. 4 is a perspective view illustrating an example of a connection structure including a clutch link, a first drive link, and a flap of the active air flap device.

FIG. 5 is an assembled perspective view showing the active air flap device.

FIG. 6 is an enlarged perspective view showing an example of a main portion of the active air flap device, where the clutch link is coupled to the drive shaft.

FIG. 7 is a rear view showing the active air flap device.

FIGS. 8A to 8D are cross-sectional views taken along line A-A of FIG. 7, which sequentially show the operating state of the active air flap device.

FIG. 9 is a side view illustrating an example of a closed state of the active air flap device.

FIG. 10 is a side view illustrating an example of an open state of the active air flap device.

FIG. 11 is a cross-sectional view taken along line B-B of FIG. 9.

FIG. 12 is a cross-sectional view taken along line C-C of FIG. 9.

In the figures, the reference numbers refer to the same or equivalent parts of the present disclosure throughout the several figures of the drawing.

### DETAILED DESCRIPTION

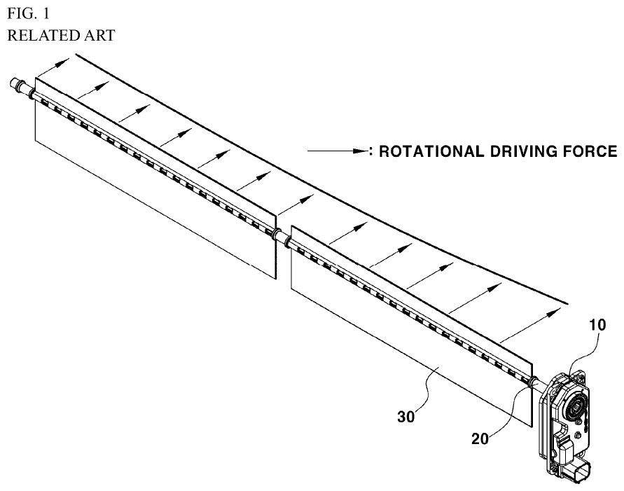

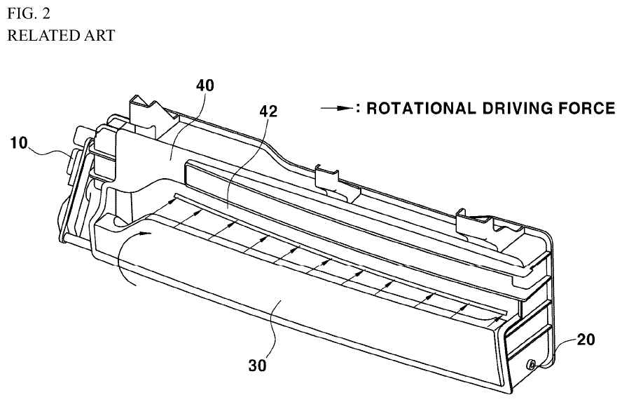

To help understand the present disclosure, the configuration and operation flow of an active air flap in related art will be described with reference to FIGS. 1 and 2 as follows.

FIG. 1 illustrates a built-in type active air flap in related art, and FIG. 2 illustrates an external type active air flap in related art.

For example, the built-in type active air flap in related art includes, as illustrated in FIG. 1, an actuator 10, a drive shaft 20 connected to an output portion of the actuator 10, and a flap 30 mounted to the drive shaft 20.

The external type active air flap in related art includes, as illustrated in FIG. 2, an actuator 10, a drive shaft 20 connected to an output portion of the actuator 10, a flap 30 disposed to be openable and closable at an air passage 42 in a housing 40, and a drive link configured to transmit the rotational driving force of the drive shaft 20 to the flap 30 by being connected between the drive shaft 20 and the flap 30.

The rotational driving force of the actuator 10 is properly transmitted to one end portion of the drive shaft 20 connected to the output portion of the actuator 10. However, because the drive shaft 20 is long, the rotational driving force of the actuator 10 may not be properly transmitted to another end portion of the drive shaft 20 that is away from the output portion of the actuator 10.

For example, the rotational driving force F of the actuator 10 is properly transmitted to the one end portion of the drive shaft 20, allowing the one end portion of the drive shaft 20 to rotate at a set angle of 90°. However, because the rotational driving force F of the actuator 10 may not be properly transmitted to the other end portion of the drive shaft 20 away from the output portion of the actuator 10, the other end portion of the drive shaft 20 may be rotated at 80°, which is smaller than the set angle.

In some cases, although one end portion of the flap 30 may be rotated at the set angle of 90° by the rotational driving force F transmitted from the one end portion of the drive shaft 20, another end portion of the flap 30 is rotated at 80°, which is smaller than the set angle, by the rotational driving force F transmitted from the other end portion of the drive shaft 20, twisting the flap due to the difference in rotation angle between the one end portion and the other end portion of the flap 30.

To be more specific, although the one end portion of the flap that receives the rotational driving force F from the one end portion of the drive shaft 20 may be rotated in a closing direction by the set angle, the rotational driving force transmitted from the actuator 10 gradually decreases toward the other end portion of the drive shaft 20, and at the same time, the rotational driving force F transmitted from the drive shaft 20 gradually decreases toward the other end portion of the flap 30, making the other end portion of the flap 30 to rotate approximately 5° to 15° less than the set angle compared to the one end portion of the flap 30, which may cause twisting of the flap 30.

In the state of the flap 30 being twisted due to the other end portion thereof being rotated less than the one end portion thereof, a gap is generated between the air passage 42 in the housing 40 and the other end portion of the flap 30 when the flap 30 is closed, causing aerodynamic loss, such as, outside air being passed through the gap, thereby limiting the flap 30 from performing its original function as blocking outside air by being completely closed to reduce driving resistance.

The present disclosure provides an active air flap configured to allow not only one end portion of a flap but also another end portion of the flap to be easily rotated to a full closing position, preventing generating a gap between an air passage in a housing and the other end portion of the flap when the flap is closed, and thus preventing aerodynamic loss, such as, outside air being passed through the gap.

Hereinafter, example implementations of the present disclosure will be described in detail with reference to the accompanying drawings.

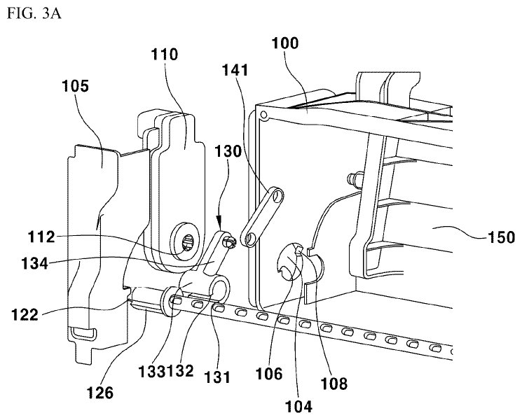

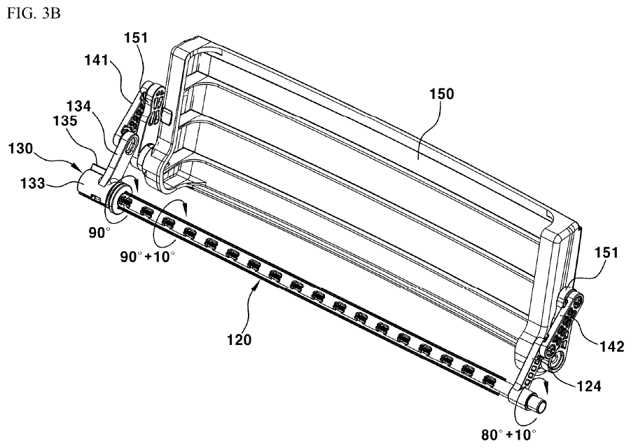

FIGS. 3A and 3B and FIGS. 4 and 5 are perspective views illustrating an example of an active air flap device for a vehicle according to the present disclosure.

In some implementations, as illustrated in FIGS. 3, 4, and 5, a housing 100 has formed therein an air passage 102 passing through the housing 100 in a front-rear direction, and a flap 150 configured to open and close the air passage 102 is rotatably disposed in the air passage 102.

An actuator 110 is mounted on the external surface of one side wall of the housing 100, and a drive shaft 120 having a predetermined length is connected to the actuator 110.

More specifically, the drive shaft 120 is disposed in a left-right direction at a position a predetermined distance away from a rear surface portion of the flap 150 and a predetermined height away from a bottom surface of the housing 100, and one end of the drive shaft 120 passes through a through hole 104 formed in the one side wall of the housing 100 to be connected to the actuator 110.

In some implementations, an internal gear 112, which is an output gear, is mounted in the output portion of the actuator 110, and an external gear 122 meshing with the internal gear 112 is provided at the one end of the drive shaft 120.

With this structure, a rotational force resulting from the driving of the actuator 110 is output to the external gear 122 through the internal gear 112, thereby rotating the drive shaft 120.

Specifically, a clutch link 130 is coupled to the one end portion of the drive shaft 120 to enable simultaneous rotation thereof.

The clutch link 130 has a structure in which the clutch link 130 rotates together with the drive shaft 120 up to the set angle to transmit the rotational driving force to the one end portion of the flap 150, and then the drive shaft 120 is further rotated by an arbitrary angle from the set angle.

In some examples, the clutch link 130 may include a lower fastening tube 133 having a structure in which a first cut surface 131 and a second cut surface 132 facing each other are spaced apart from each other, an upper fastening rod 134 extending upward from the lower fastening tube 133, and a stopper 135 protruding from an external side end portion of the lower fastening tube 133.

The lower fastening tube 133 of the clutch link 130 is rotatably inserted into the through hole 104 formed in the one side wall of the housing 100, and the one end portion of the drive shaft 120 is inserted to be fastened to the lower fastening tube 133.

Here, when the drive shaft 120 rotates as the actuator 110 is driven while the one end portion of the drive shaft 120 is inserted to be fastened to the lower fastening tube 133, the lower fastening tube 133 may also rotate together therewith, and eventually, the drive shaft 120 and the clutch link 130 may rotate together.

In some implementations, as illustrated in FIG. 6, the first cut surface 131 and the second cut surface 132 of the lower fastening tube 133 each may be provided with an elastic pressing end 136 being pressed to the surface of the drive shaft 120, wherein the elastic pressing ends 136 are integrated with the first cut surface 131 and the second cut surface 132, respectively.

Accordingly, the elastic pressing ends 136 of the lower fastening tube 133 are pressed against the surface of the drive shaft 120 by an elastic restoring force, eliminating the gap between the lower fastening tube 133 and the drive shaft 120 to allow easy rotation of the lower fastening tube 133 when the drive shaft 120 rotates as the actuator 110 is driven, and eventually, when the drive shaft 120 rotates, the clutch link 130 including the lower fastening tube 133 and the upper fastening rod 134 may rotate together therewith.

Here, the clutch link 130 is configured to rotate up to a set angle (e.g.,) 90° when rotating together with the drive shaft 120.

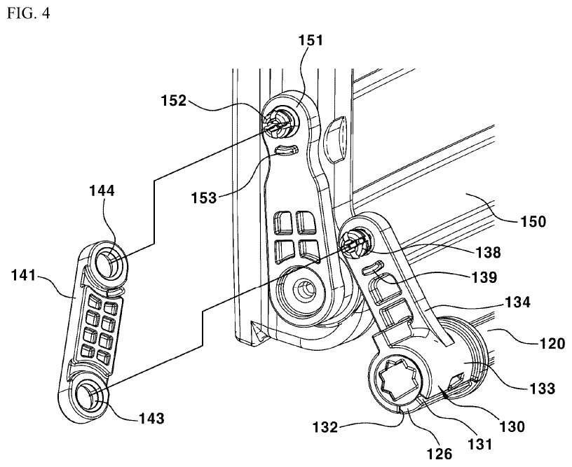

In some implementations, as well shown in FIG. 4, the stopper 135 protrudes from the external side end portion of the lower fastening tube 133, and as well shown in FIG. 3A, an outer circumferential portion of the through hole 104 in the housing 100 has a first rotation limiting end 106 and a second rotation limiting end 108, separated from each other and brought into contact with the stopper 135.

With this structure, when the drive shaft 120 rotates as the actuator 110 is driven, the clutch link 130 rotates together therewith but the stopper 135 of the clutch link 130 is brought into contact with the first rotation limiting end 106 or with the second rotation limiting end 108, limiting the rotation angle of the clutch link 130 rotating together with the drive shaft 120 to the set angle.

For example, when the drive shaft 120 and the clutch link 130 rotate together, the stopper 135 of the clutch link 130 is brought into contact with the first rotation limiting end 106 or with the second rotation limiting end 108, allowing the clutch link 130 to rotate only up to the set angle of 90°.

On the other hand, the drive shaft 120 is configured to rotate further by an arbitrary angle (e.g., 10°), after rotating together with the clutch link 130 up to the set angle.

In some examples, the one end portion of the drive shaft 120 has a rotation compensating end 126, protruding therefrom and disposed between the first cut surface 131 and the second cut surface 132 formed at the lower fastening tube 133 of the clutch link 130.

Accordingly, when the drive shaft 120 is further rotated by an arbitrary angle from the set angle after the drive shaft 120 and the clutch link 130 are rotated together up to the set angle, the rotation compensating end 126 is brought into contact with the first cut surface 131 or with the second cut surface 132 of the clutch link 130 to determine the arbitrary angle at which the drive shaft 120 is further rotated from the set angle.

For example, in the state in which the rotational driving force of the actuator 110 is continuously applied to the drive shaft 120 after the one end portion of the drive shaft 120 and the clutch link 130 are rotated together to the set angle of 90°, the one end portion of the drive shaft 120 may be further rotated by the arbitrary angle of 10° from the set angle of 90° until the rotation compensating end 126 is brought into contact with the first cut surface 131 or with the second cut surface 132 of the clutch link 130.

Here, when the one end portion of the drive shaft 120 further rotates by the arbitrary angle of 10° from the set angle of 90°, the other end portion of the drive shaft 120 may be rotated up to the set angle of 90°.

More specifically, the rotational driving force of the actuator 110 may not be properly transmitted to the other end portion of the drive shaft 120 that is away from the output portion of the actuator 110, rotating the other end portion of the drive shaft 120 up to about 80° when the one end portion of the drive shaft 120 and the clutch link 130 are rotated together to the set angle of 90°. However, as the drive shaft 120 continues to rotate further by the arbitrary angle of 10°, the one end portion of the drive shaft 120 may rotate up to) 100° (90°+10°), and at the same time, the other end portion of the drive shaft 120 may rotate up to the set angle of) 90° (80°+10°).

In some examples, as in FIG. 3B, a transmission link 124 is integrally fastened to the other end portion of the drive shaft 120, and when the other end portion of the drive shaft 120 is further rotated by an arbitrary angle (e.g., 10°), the transmission link 124 serves to transmit the rotational driving force to the other end portion of the flap 150 while rotating by the same angle as the arbitrary angle.

Therefore, when the one end portion of the drive shaft 120 rotates together with the clutch link 130, the clutch link 130 may transmit the rotational driving force to the one end portion of the flap 150 while rotating by the set angle of 90°, and in addition thereto, the drive shaft 120 rotates further by an arbitrary angle (e.g., 10°) from the set angle, allowing the other end portion of the drive shaft 120 and the transmission link 124 to rotate by the set angle of 90° (80°+10°) to transmit the rotational driving force to the other end portion of the flap 150.

In some examples, so as to transmit the rotational driving force to the one end portion of the flap 150, a first drive link 141 configured to rotate the one end portion of the flap 150 in an opening or closing direction may be hinged between the upper fastening rod 134 of the clutch link 130 and a fixed link 151 mounted on one side surface of the flap 150, and so as to transmit the rotational driving force to the other end portion of the flap 150, a second drive link 142 configured to rotate the other end portion of the flap 150 in the opening or closing direction may be hinged between the transmission link 124 and a fixed link 151 mounted to another side surface of the flap 150.

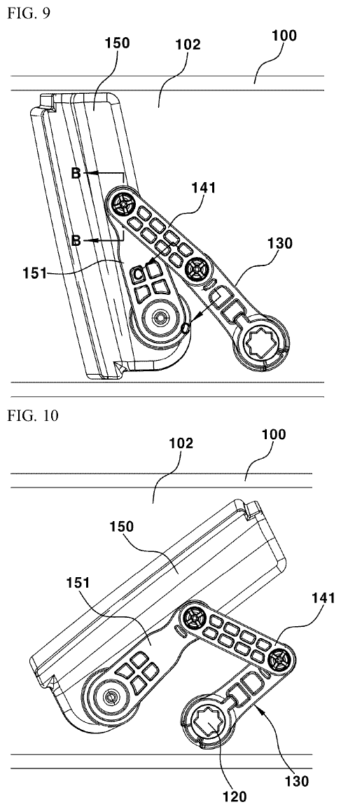

With this structure, as the clutch link 130 rotates forward by the set angle to rotate the first drive link 141 in a closing direction, the first drive link 141 pushes the one end portion of the flap 150 in the closing direction, and as the transmission link 124 rotates forward by the set angle to rotate the second drive link 142 in the closing direction, the second drive link 142 pushes the other end portion of the flap 150 in the closing direction. By doing so, the flap 150 may be placed in a closed position where the flap 150 closes the air passage 102 in the housing 100, as illustrated in FIG. 9.

In some examples, as the clutch link 130 rotates rearward by the set angle to rotate the first drive link 141 in an opening direction, the first drive link 141 pulls the one end portion of the flap 150 in the opening direction, and as the transmission link 124 rotates rearward by the set angle to rotate the second drive link 142 in the opening direction, the second drive link 142 pulls the other end portion of the flap 150 in the opening direction. Accordingly, the flap 150 may be placed in an open position where the flap 150 opens the air passage 102 in the housing 100, as illustrated in FIG. 10.

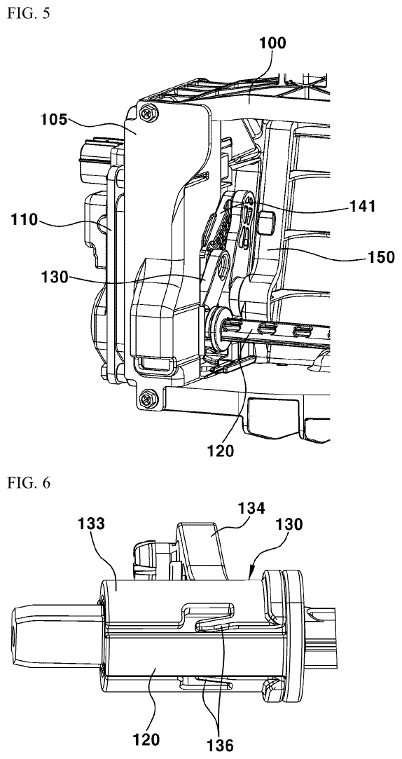

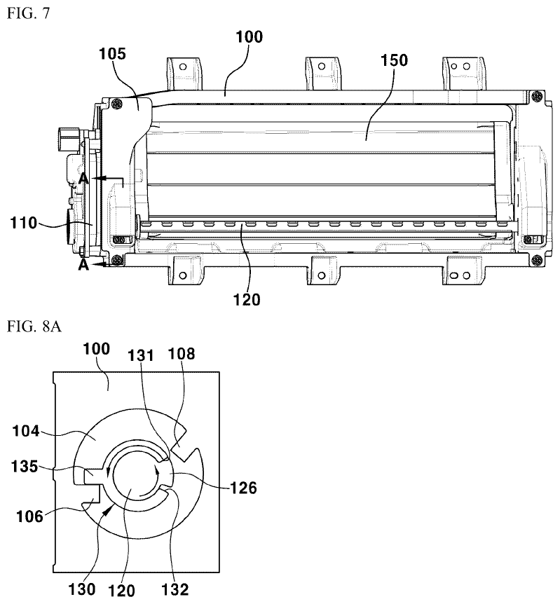

In some examples, as illustrated in FIG. 5, one side portion of the housing 100 has detachably mounted thereto a protection cover 105 configured to protect the one end portion of the drive shaft 120, the clutch link 130, the first drive link 141, etc.

Accordingly, the protection cover 105 may block foreign substances from being introduced into the one end portion of the drive shaft 120, the clutch link 130, the first drive link 141, etc. in normal times, and may be detached during maintenance for the one end portion of the drive shaft 120, the clutch link 130, the first drive link 141, etc.

Here, the operation flow for the active air flap device for a vehicle of the present disclosure having the structure as described above is as follows.

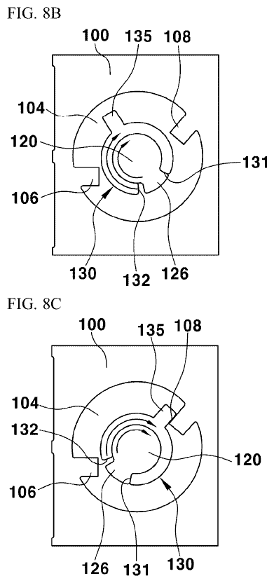

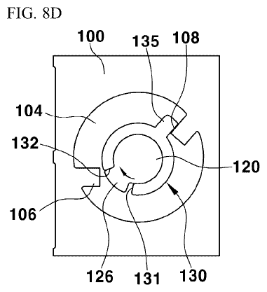

In some implementations, as illustrated in FIG. 8A, in the state the flap 150 is in the open position where the air passage 102 in the housing 100 is open, the stopper 135 of the clutch link 130 is kept being brought into contact with the first rotation limiting end 106 of the housing 100, and the rotation compensating end 126 of the drive shaft 120 is kept being brought into contact with the first cut surface 131 of the clutch link 130.

Thereafter, when the rotational driving force is transmitted to the drive shaft 120 of the actuator 110 to close the flap 150, the one end portion of the drive shaft 120 and the clutch link 130 rotate together to a set angle (e.g., 90°).

To be more specific, because the one end portion of the drive shaft 120 is inserted to be fastened to the lower fastening tube 133 of the clutch link 130, the one end portion of the drive shaft 120 and the clutch link 130 rotate together to the set angle (e.g., 90°) as illustrated in FIGS. 8B and 8C, and as the stopper 135 of the clutch link 130 is brought into contact with the second rotation limiting end 108 of the housing 100 as illustrated in FIG. 8C, the clutch link 130 rotates only up to the set angle (e.g., 90°).

Here, because the rotational driving force of the actuator 110 may not be properly transmitted to the other end portion of the drive shaft 120 that is away from the output portion of the actuator 110, the other end portion of the drive shaft 120 is rotated up to about 80° when the one end portion of the drive shaft 120 and the clutch link 130 are rotated together to the set angle of 90°.

Subsequently, as the rotational driving force of the actuator 110 continues to be applied to the drive shaft 120 after the one end portion of the drive shaft 120 and the clutch link 130 are rotated together to the set angle of 90°, the one end portion of the drive shaft 120 is, as illustrated in FIG. 8D, further rotated by an arbitrary angle of 10° from the set angle of 90° until the rotation compensating end 126 is brought into contact with the second cut surface 132 of the clutch link 130.

At the same time, when the one end portion of the drive shaft 120 is further rotated by the arbitrary angle of 10° from the set angle of 90°, the other end portion of the drive shaft 120 is rotated by the set angle of 90°.

More specifically, the rotational driving force of the actuator 110 may not be properly transmitted to the other end portion of the drive shaft 120 that is away from the output portion of the actuator 110, rotating the other end portion of the drive shaft 120 only up to about 80° when the one end portion of the drive shaft 120 and the clutch link 130 are rotated together to the set angle of 90°. However, as the drive shaft 120 continues to rotate further by the arbitrary angle of 10°, the one end portion of the drive shaft 120 may rotate up to) 100° (90°+10°), and at the same time, the other end portion of the drive shaft 120 may rotate up to the set angle of 90° (80°+10°).

Therefore, when the one end portion of the drive shaft 120 rotates together with the clutch link 130, the clutch link 130 rotates up to the set angle of 90° to transmit the rotational driving force for full closing to the one end portion of the flap 150 via the first drive link 141 and the fixed link 151, and together therewith, the drive shaft 120 rotates further by an arbitrary angle (e.g., 10°) from the set angle, allowing the other end portion of the drive shaft 120 and the transmission link 124 to rotate by the set angle of 90° (80°+10°) and transmitting the rotational driving force for full closing to the other end portion of the flap 150 via the second drive link 142 and the fixed link 151.

For example, as the rotational driving force generated when the clutch link 130 rotates by the set angle of 90° is transmitted to the one end portion of the flap 150 via the first drive link 141 and the fixed link 151, the one end portion of the flap 150 may rotate by the set angle of 90° for full closing, and together therewith, the drive shaft 120 rotates further by an arbitrary angle (e.g., 10°) from the set angle, allowing the rotational driving force generated when the other end portion of the drive shaft 120 and the transmission link 124 rotate by the set angle of 90° (80°+10°) to be transmitted to the other end portion of the flap 150 via the second drive link 142 and the fixed link 151, so that the other end portion of the flap 150 may also rotate by the set angle of 90° for full closing.

Accordingly, the one end portion and the other end portion of the flap 150 are rotated at the same angle for opening and closing, preventing twisting of the flap due to the other end portion of the flap being rotated approximately 5° to 15° less than the set angle compared to the one end portion of the flap, which was a problem in the prior art.

Moreover, the one end portion of the flap 150 and the other end portion of the flap 150 are easily rotated at the same angle to the closed position, preventing generating a gap between the air passage 102 in the housing 100 and the other end portion of the flap 150 when the flap is closed, thereby preventing aerodynamic loss, such as, outside air passing through the gap.

As such, so as to compensate for the rotation loss in the prior art in which the other end portion of the flap rotates less than the one end portion of the flap and fails to reach the closed position, the clutch link 130 is rotated up to the set angle and the drive shaft 120 connected to the actuator 110 is further rotated by an arbitrary angle from the set angle, allowing the one end portion of the flap 150 and the other end portion of the flap 150 to rotate at the same angle to the closed position. Moreover, when closing the flap 150, the air passage 102 in the housing 100 may be completely blocked without creating a gap, and thus the original function of the active air flap, which is to reduce driving resistance caused by air flow, may be performed accurately without any errors.

Referring to FIG. 4, a first hinge fin 138 is formed on the external surface of the upper end portion of the upper fastening rod 134 of the clutch link 130, and a first hinge hole 143 into which the first hinge fin 138 is inserted is formed in the lower end portion of the first drive link 141.

Furthermore, at a position below the first hinge fin 138 on the external surface of the upper fastening rod 134, a first impact support rib 139 configured to support the lower end portion of the first drive link 141 is formed to protrude therefrom.

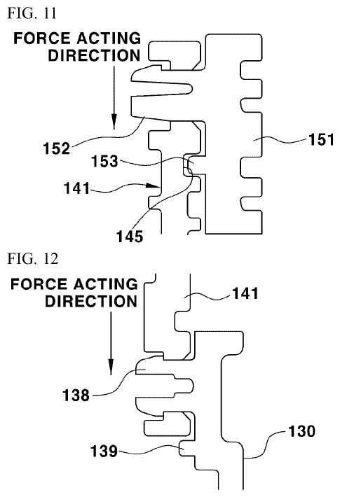

With this structure, even when a vertical external force acts on the first drive link 141 in the state where the flap 150 is closed, the first impact support rib 139 performs, as illustrated in FIG. 12, buffering and supporting actions to support the first drive link 141, preventing damage to the first drive link 141, the first hinge fin 138, etc.

Referring to FIG. 4, the one side surface of the flap 150 has mounted thereto the fixed link 151 including a second hinge fin 152, and the upper end portion of the first drive link 141 has formed therein a second hinge hole 144 into which the second hinge fin 152 is inserted.

Moreover, at a position below the second hinge fin 152 on the fixed link 151, a second impact support rib 153 configured to support the upper end portion of the first drive link 141 by being inserted into a support groove 145 formed in an inner surface of the upper end portion of the first drive link 141 is formed to protrude therefrom.

Therefore, even when a vertical external force acts on the first drive link 141 in the state where the flap 150 is closed, the second impact support rib 153 is inserted, as illustrated in FIG. 11, into the support groove 145 in the first drive link 141 to perform buffering and supporting actions to support the upper end portion of the first drive link 141, preventing damage to the first drive link 141, the second hinge fin 152, etc.

As is apparent from the above description, the present disclosure provides the following effects.

In some implementations, when a drive shaft connected to an actuator and a clutch link fastened to the drive shaft rotate together to transmit a rotational driving force for opening and closing a flap to a drive link, the clutch link is rotated up to a set angle, and the drive shaft is further rotated by an arbitrary angle from the set angle, compensating for a rotation loss in which another end portion of the flap rotates less than one end portion of the flap.

For example, to compensate for the rotation loss in which the other end portion of the flap rotates less than the one end portion of the flap and fails to reach a closed position, the clutch link is rotated up to the set angle, and the drive shaft connected to the actuator is further rotated by the arbitrary angle from the set angle, allowing not only the one end portion of the flap but also the other end portion of the flap to be easily rotated up to the closed position.

In some implementations, not only the one end portion of the flap but also the other end portion of the flap are easily rotated up to the closed position, preventing generating a gap between an air passage in a housing and the other end portion of the flap when the flap is closed, and thus preventing aerodynamic loss, such as, outside air passing through the gap.

In some implementations, when closing the flap, the air passage in the housing may be completely covered to block outside air, such as a travelling wind, from being introduced into a radiator, etc., allowing the original function of the active air flap, which is to reduce driving resistance caused by air flow, to be performed accurately without any errors.

Although the present disclosure has been described in detail with reference to one implementation, the scope of the present disclosure is not limited to the above-described implementation, and various modifications and improvements by those skilled in the art based on the basic concept of the present disclosure as defined in the claims below will also be included in the scope of the present disclosure.

What is claimed is:

1. An active air flap device for a vehicle, the device comprising:
a housing that defines an air passage therein;
a flap configured to open and close the air passage;
an actuator disposed at a first side portion of the housing;
a drive shaft connected to the actuator;
a clutch link coupled to a first end portion of the drive shaft and configured rotate together with the drive shaft to a set angle to thereby transmit a rotational driving force of the actuator to a first end portion of the flap, the clutch link being configured to allow the drive shaft to rotate further by an arbitrary angle from the set angle; and
a transmission link coupled to a second end portion of the drive shaft and configured to rotate by the arbitrary angle to thereby transmit the rotational driving force to a second end portion of the flap based on the drive shaft rotating further by the arbitrary angle from the set angle.

2. The device of claim 1, further comprising:
a first drive link hinged between the clutch link and the first side portion of the flap and configured to rotate the flap in an opening direction or a closing direction; and
a second drive link hinged between the transmission link and a second side portion of the flap and configured to rotate the flap in the opening direction or the closing direction.

3. The device of claim 1, wherein the actuator comprises an internal gear configured to output the rotational driving force, and
wherein the drive shaft comprises an external gear that is disposed at an end of the drive shaft and meshes with the internal gear.

4. The device of claim 2, wherein the clutch link comprises:
a lower fastening tube that receives and fastens the first end portion of the drive shaft, the lower fastening tube having a first cut surface and a second cut surface that face each other and are spaced apart from each other, the lower fastening tube being inserted into a through hole defined at a side wall of the housing;
an upper fastening rod that extends from the lower fastening tube and is coupled to the first drive link; and
a stopper that protrudes from an external side end portion of the lower fastening tube.

5. The device of claim 4, wherein the clutch link further comprises an elastic pressing end that is disposed at each of the first cut surface and the second cut surface and configured to pressed by a surface of the drive shaft.

6. The device of claim 4, wherein the drive shaft has a rotation compensating end that protrudes from the first end portion of the drive shaft and is disposed between the first cut surface and the second cut surface of the clutch link.

7. The device of claim 4, wherein the housing comprises a first rotation limiting end and a second rotation limiting end that are disposed at an outer circumferential portion of the through hole of the housing and configured to contact the stopper to thereby limit a rotation angle of the clutch link rotating together with the drive shaft to the set angle.

8. The device of claim 4, wherein the clutch link further comprises a first hinge fin disposed at an external surface of an upper end portion of the upper fastening rod of the clutch link, and
wherein the first drive link defines a first hinge hole at a lower end portion of the first drive link, the first hinge hole receiving the first hinge fin.

9. The device of claim 8, wherein the clutch link further comprises a first impact support rib that is disposed below the first hinge fin on the external surface of the upper fastening rod and configured to support the lower end portion of the first drive link.

10. The device of claim 4, further comprising a fixed link that is disposed at a side surface of the flap and comprises a second hinge fin,
wherein the first drive link define a second hinge hole at an upper end portion of the first drive link, the second hinge hole receiving the second hinge fin.

11. The device of claim 10, wherein the fixed link further comprises a second impact support rib that is disposed at a position below the second hinge fin and configured to support the upper end portion of the first drive link, the second impact support rib protruding from the fixed link, and
wherein the first drive link defines a support groove at an inner surface of the upper end portion of the first drive link, the support groove receiving the second impact support rib.

12. The device of claim 7, wherein the stopper of the clutch link is configured to, based on the drive shaft and the clutch link rotating together, be brought into contact with the first rotation limiting end or the second rotation limiting end to thereby allow the clutch link to rotate to the set angle of 90°.

13. The device of claim 6, wherein the drive shaft is configured to rotate further by the arbitrary angle of 10° from the set angle based on the rotation compensating end being brought into contact with the first cut surface or the second cut surface of the clutch link.

14. The device of claim 4, further comprising a protection cover that is disposed at the first side portion of the housing and covers the first end portion of the drive shaft, the clutch link, and the first drive link.
